(19) United States
(12) Patent Application Publication
(10) Pub. No.: US 2008/0174646 A1
(43) Pub. Date: Jul. 24, 2008

(54) Ink composition, ink for inkjet recording, ink set for inkjet recording, inkjet recording apparatus and inkjet recording method

(75) Inventor: Terukazu Yanagi, Kanagawa-ken (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/802,804

(22) Filed: May 25, 2007

(30) Foreign Application Priority Data
Jun. 19, 2006 (JP) 2006-168792

(51) Int. Cl. G01D 11/00; C08L 53/00; C11D 11/02; C08K 3/08

(52) U.S. Cl. 347/100; 524/502; 524/439

(57) ABSTRACT

The ink composition includes: a coloring material; a resin which is a block copolymer constituted of at least one hydrophilic block and at least one hydrophobic block; and one of an element and a compound of a polyvalent metal having an atomic weight of not less than 65. The mol ratio of the resin to the one of the element and the compound of the polyvalent metal is 1:6 through 10000:1.

### BACKGROUND OF THE INVENTION

1. Field of the Invention

The present invention relates to an ink composition and an ink for inkjet recording particularly suitable for use in an inkjet recording apparatus and having good fixing characteristics.

2. Description of the Related Art

An inkjet recording method has been commonly known as an image forming method. In the field of the inkjet recording method, there are demands for higher image definition, increased printing speed and fixing speed, and from an ecological viewpoint, there are also growing demands for reduced energy consumption. The major demands in image formation are for increased speed of the fixing process and improved image definition. In order to comply with these, inkjet recording methods that adopt high-speed fixing processes with low energy consumption have been investigated.

For example, Japanese Patent Application Publication No. 8-253717 discloses the use of reactive ink containing a reactive coloring material, Japanese Patent Application Publication No. 6-49399 discloses the use of a compound having reversible thermal gelation characteristics, and Japanese Patent Application Publication No. 2004-217915 discloses the use of an aluminum compound. However, the fixing processes described in these are not yet satisfactory in terms of high-speed fixing characteristics.

### SUMMARY OF THE INVENTION

The present invention has been contrived in view of these circumstances, an object thereof being to provide an ink composition and an ink for inkjet recording, which has excellent fixing characteristics, enables stable ejection from nozzles, and achieves good wear resistance, water resistance and marker resistance in the formed image.

In order to attain the aforementioned object, the present invention is directed to an ink composition, comprising: a coloring material; a resin which is a block copolymer constituted of at least one hydrophilic block and at least one hydrophobic block; and one of an element and a compound of a polyvalent metal having an atomic weight of not less than 65, wherein a mol ratio of the resin to the one of the element and the compound of the polyvalent metal is 1:6 through 10000:1.

By using the block copolymer constituted of a hydrophobic block and a hydrophilic block in the ink composition, it is possible for the hydrophobic block to adhere uniformly on the surface of a particle of the coloring material, and hence the block copolymers uniformly coats the coloring material particle in such a manner that the coloring material particle is not exposed, thereby enabling the formation of a capsule.

This capsule state is maintained stably even when ejecting the ink in an inkjet recording apparatus where the dispersion is liable to become unstable, and hence ejection stability is improved. Moreover, since the hydrophilic part of the high-molecular-weight dispersant forms a block, then it has good affinity with the ink medium, and the dispersion stability of the coloring material is greatly improved. Therefore, aggregation or sedimentation of the coloring material in the ink becomes less liable to occur, and in addition to achieving good ejection stability, the long-term storage stability of the ink is also improved.

Further, since the ink composition includes an element or compound of a polyvalent metal having the atomic weight of not less than 65, the resin and the polyvalent metal contained in the ink composition have an action of fixing the coloring material on the recording medium, such as paper, after deposition of the ink composition on the recording medium. Consequently, the formed image has good wear resistance, water resistance and marker resistance.

Furthermore, by setting the mol ratio of the resin to the element or compound of the polyvalent metal to 1:6 through 10000:1, it is possible to improve the ink fixing properties when forming images. If the mol ratio of the polyvalent metal to the resin is too little, then there may be cases where the wear resistance, water resistance and marker resistance of the formed image, and the fixing properties of the ink on the recording medium, become unsatisfactory. Therefore, the polyvalent metal is preferably contained in the ink composition at a ratio of 10000:1 or above. On the other hand, if the mol ratio of the polyvalent metal to the resin is too high, then there may be cases where the ejection stability of the aqueous ink declines. Therefore, the polyvalent metal is preferably contained in the ink composition at a ratio of 1:6 or less.

Consequently, according to the above-described aspect of the present invention, in the ink composition containing the coloring material and the resin, since the resin is the block copolymer containing at least one hydrophilic block and at least one hydrophobic block, the ink composition contains the element or compound of the polyvalent metal having the atomic weight of 65 or above, and the mol ratio of the resin to the polyvalent metal is 1:6 through 10000:1, then it is possible to provide an ink composition that has excellent fixing properties, enables stable ejection from nozzles, and achieves good wear resistance, water resistance and marker resistance, of the formed image, when used in an inkjet recording apparatus.

Preferably, the block copolymer is a vinyl ether copolymer.

According to this aspect of the present invention, since the block copolymer is a vinyl ether copolymer, then the stability of the dispersion of the coloring material in the ink solvent is further improved, and hence the ejection stability from the nozzles in an inkjet recording apparatus is further improved.

Preferably, the polyvalent metal belongs to fourth through seventh periods in periodic table.

According to this aspect of the present invention, since the polyvalent metal is an element belonging to the fourth through seventh periods in the periodic table, then the coloring material is readily fixed to the recording medium.

Preferably, the polyvalent metal has not less than three valences.

According to this aspect of the present invention, since the polyvalent metal has three or more valences, then the coloring material is readily fixed to the recording medium.

More preferably, the polyvalent metal is tin. The polyvalent metal of tin is more preferable in terms of improving the fixing properties of the coloring material on the recording medium.

Preferably, the mol ratio of the resin to the one of the element and the compound of the polyvalent metal is 100:5 through 1000:1.

According to this aspect of the present invention, by setting the mol ratio between the resin and the polyvalent metal within a more desirable range, which is 100:5 to 1000:1, it is possible further to improve the ink fixing properties when forming images.

Preferably, the coloring material is dispersed in liquid.

According to this aspect of the present invention, since the coloring material is dispersed in liquid, then it is possible to form a stable dispersion.

Preferably, the ink composition further includes at least one of a hydrophilic organic solvent and water.

According to this aspect of the present invention, since the ink composition also contains a hydrophilic organic solvent and/or water, then it is suitable for use in an inkjet recording apparatus.

In order to attain the aforementioned object, the present invention is also directed to an ink for inkjet recording having the above-described ink composition. Moreover, the present invention is also directed to an ink set for inkjet recording including this ink for inkjet recording.

In order to attain the aforementioned object, the present invention is also directed to an inkjet recording apparatus including the above-described ink for inkjet recording or the above-described ink set for inkjet recording.

In order to attain the aforementioned object, the present invention is also directed to an inkjet recording method including the step of forming an image on a recording medium by means of an inkjet recording apparatus using the above-described ink for inkjet recording or the above-described ink set for inkjet recording.

Preferably, the recording medium is art paper. The present invention is especially beneficial in cases where the ink recording medium is an art paper.

According to the present invention, it is possible to provide an ink composition and an ink for inkjet recording, which has excellent wear resistance, water resistance and marker resistance, and which enables good ejection stability in nozzles and excellent high-speed fixing characteristics.

### DETAILED DESCRIPTION OF THE PREFERRED EMBODIMENTS

The nature of this invention, as well as other objects and benefits thereof, will be explained in the following. An ink composition according to an embodiment of the present invention contains a coloring material, resin, and one of an element and a compound of a polyvalent metal having the atomic weight of not less than 65. In other words, the ink composition is composed of the coloring material, the resin, and the polyvalent metal element having the atomic weight of not less than 65, or the ink composition is composed of the coloring material, the resin, and the compound constituted of the polyvalent metal having the atomic weight of not less than 65. The resin and the one of the element and the compound of the polyvalent metal having the atomic weight of not less than 65, contained in the ink composition, have an action of fixing the coloring material on a recording medium, such as paper, after deposition of the ink composition on the recording medium.

The resin used in the ink composition is a block copolymer composed of at least one type of hydrophilic block and at least one type of hydrophobic block. It is possible that the resin is a block copolymer composed of two or more types of hydrophilic blocks and two or more types of hydrophobic blocks. It is also possible that the resin is a single type of block copolymer or a combination of two or more types of block copolymers. It is possible that the resin is the copolymer having a straight chain structure or the copolymer having a grafted structure, or the like, and it is desirable that the resin is the copolymer having the straight chain structure.

It is desirable that the resin has a polyvinyl ether structure formed by polymerizing a vinyl ether monomer, in order to form a stable dispersion with particles of the coloring material. Moreover, it is desirable that the hydrophilic block composing the resin is an anionic polyvinyl ether block, or a diblock constituted of a nonionic polyvinyl ether block and an anionic polyvinyl ether block, in order to form a dispersion in which the particles of the coloring material are stably dispersed in ink medium. In cases where the hydrophilic block of the resin is the diblock constituted of the nonionic polyvinyl ether block and the anionic polyvinyl ether block, then it is more desirable that the resin is the block copolymer constituted of a hydrophobic polyvinyl ether block, a hydrophilic nonionic polyvinyl ether block, and a hydrophilic anionic polyvinyl ether block, arranged in this sequence, in order to further enhance the stability of the dispersed particles of coloring material in the ink medium.

It is desirable that the hydrophobic vinyl ether block constituting the resin is a block having a repeating unit represented by the following general formula (1):

—(CH₂—CH(OR¹))—, (1)

where R¹ is: an aliphatic hydrocarbon group, such as an alkyl group, an alkenyl group, a cycloalkyl group and a cycloalkenyl group; or an aromatic hydrocarbon group (in which a carbon atom may be substituted with a nitrogen atom, and a hydrogen atom on the aromatic ring may be substituted with a hydrocarbon group), such as a phenyl group, a pyridil group, a benzyl group, a tolyl group, a xylyl group, an alkylphenyl group, a phenylalkylene group, a biphenyl group and a phenylpyridyl group. R¹ preferably has 1 through 18 carbon atoms.

Furthermore, it is possible that R¹ is a group represented as: —(CH(R²)—CH(R³)—O)ₚ—R⁴; or —(CH₂)ₘ—(O)ₙ—R⁴, where R² is a hydrogen atom or a methyl group, R³ is a hydrogen atom or a methyl group, and R⁴ is: an aliphatic hydrocarbon group, such as an alkyl group, an alkenyl group, a cycloalkyl group and a cycloalkenyl group; an aromatic hydrocarbon group (in which a carbon atom may be substituted with a nitrogen atom, and a hydrogen atom on the aromatic ring may be substituted with a hydrocarbon group), such as a phenyl group, a pyridil group, a benzyl group, a tolyl group, a xylyl group, an alkylphenyl group, a phenylalkylene group, a biphenyl group and a phenylpyridyl group; —CO—CH═CH₂; —CO—C(CH₃)═CH₂; —CH₂—CH═CH₂; or —CH₂—C(CH₃)═CH₂. In these groups, it is possible that a hydrogen atom is substituted with a halogen atom, such as fluorine, chlorine and bromine, to the extent that it is chemically feasible. R⁴ preferably has 1 through 18 carbon atoms, p is preferably 1 through 18, m is preferably 1 through 36, and n is preferably 0 or 1.

Examples of the alkyl group and the alkenyl group in R¹ and R⁴ include: methyl, ethyl, propyl, isopropyl, n-butyl, sec-butyl, t-butyl, pentyl, hexyl, heptyl, octyl, nonyl, decyl, dodecyl, tetradecyl, hexadecyl, octadecyl and oleyl. Examples of the cycloalkyl group and the cycloalkenyl group in R¹ and R⁴ include: cyclopropyl, cyclobutyl, cyclopentyl, cyclohexyl and cyclooctyl.

It is desirable that the hydrophilic vinyl ether block constituting the resin is a block having a repeating unit represented by the following general formula (2):

—(CH₂—CH(OR⁵))—, (2)

where R⁵ is a group represented as: —(CH₂—CH₂—O)ₖ—R⁶, —(CH₂)ₘ—(O)ₙ—R⁶, R⁷—X, —(CH₂—CH₂—O)ₖ—R⁷—X, or —(CH₂)ₘ—(O)ₙ—X, in which R⁶ is a hydrogen atom, a straight chain or branched alkyl group having 1 through 4 carbon atoms, —CO—CH═CH₂, —CO—C(CH₃)═CH₂, —CH₂—CH═CH₂, or —CH₂—C(CH₃)═CH₂; and R⁷ is: an aliphatic hydrocarbon group, such as an alkylene group, an alkenylene group, a cycloalkylene group and a cycloalkenylene group; or an aromatic hydrocarbon group (in which a carbon atom may be substituted with a nitrogen atom, and a hydrogen atom on the aromatic ring may be substituted with a hydrocarbon group), such as a phenylene group, a pyridylene group, a benzylene group, a tolylene group, a xylylene group, an alkylphenylene group, a phenylenealkylene group, a biphenylene group and a phenylpyridylene group. In these groups, it is possible that a hydrogen atom is substituted with a halogen atom, such as fluorine, chlorine and bromine, to the extent that it is chemically feasible. X is an anionic group selected from a carboxylic acid group, a sulfonic acid group, and a phosphoric acid group. R⁷ preferably has 1 through 18 carbon atoms, k is preferably 1 through 18, m is preferably 1 through 36, and n is preferably 0 or 1.

The following examples show monomers I-a to I-o forming the above-described repeating unit, and block copolymer structures II-a to II-e constituted of these monomers, but the structure of the block copolymer usable in the present invention is not limited to these examples.

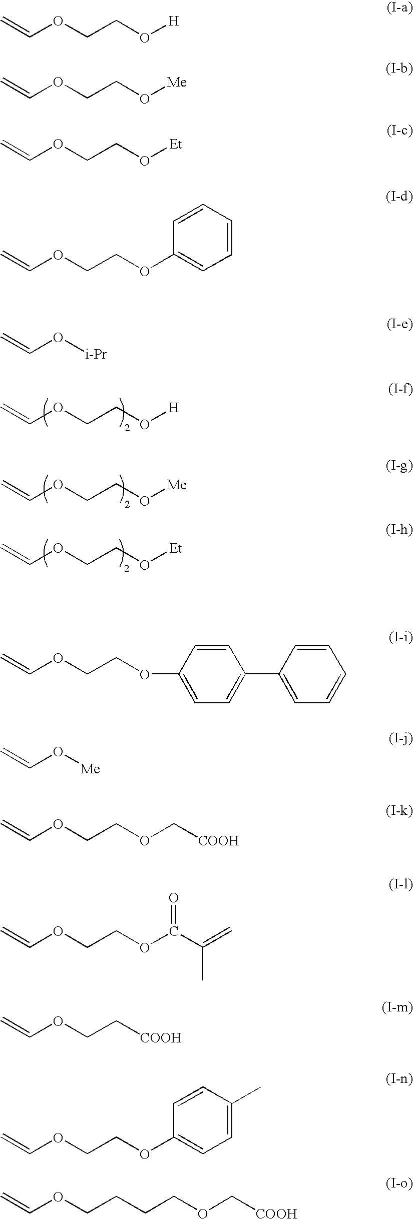

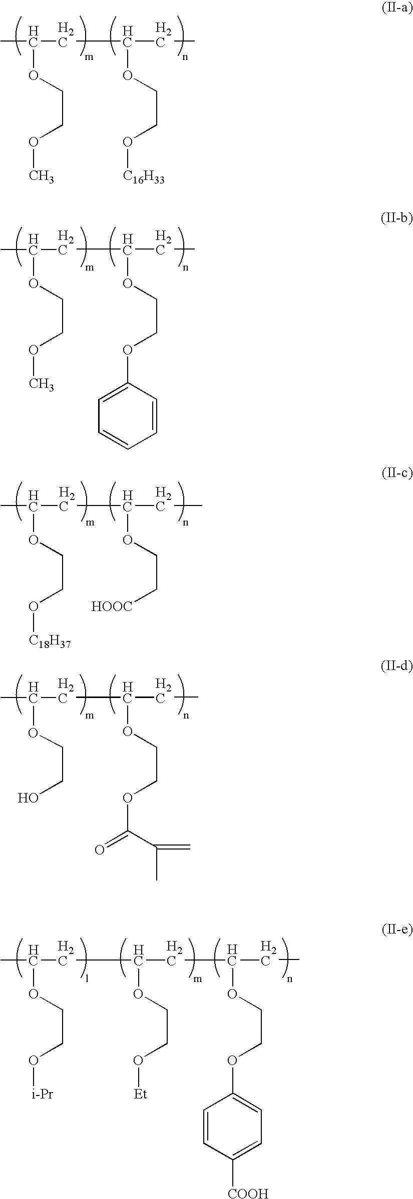

It is desirable that the numbers of the repeating units in the block copolymer (e.g., the variables m, n and 1 in each of the structures II-a to II-e) are 1 through 10,000, independently from each other. Moreover, it is desirable that the total of the numbers of the repeating units in the block copolymer (e.g., the sum of m+n+1 in each of the structures II-a to II-e) is 10 through 20,000. Furthermore, it is desirable that the number average molecular weight is 500 through 20,000,000, preferably 1,000 through 5,000,000, and even more preferably 2,000 through 2,000,000.

It is possible that the block copolymer has a structure in which the above-described polyvinyl ether block is graft bonded to another polymer block, or a structure in which the above-described vinyl ether monomer is copolymerized with another repeating unit.

Although there are no particular restrictions on the method of synthesizing the block copolymer including the repeating unit constituted of the above-described vinyl ether monomer, it is possible to use a living cationic polymerization method, in order to synthesize various polymers, such as homopolymers that have an accurately controlled chain length (molecular weight), copolymers including two or more constituent monomers, block copolymers, graft polymers, graduation polymers. Moreover, it is also possible to incorporate various types of functional groups into the side chains of these block copolymers.

The ink composition according to the embodiment of the present invention is composed of the compound or element of the polyvalent metal having the atomic weight of not less than 65, in addition to the above-described resin (block copolymer). It is desirable that the polyvalent metal belongs to the fourth through seventh periods of the periodic table, preferably to the fifth through sixth periods, and even more preferably to the fifth period. Examples of the polyvalent metal compound (the compound composed of the polyvalent metal) include a hydrochloride, a sulfate or a nitrate, constituted of Ga, Rb, Sr, Y, Zr, Nb, Mo, Tc, Ru, Rh, Pd, Ag, Cd, In, Cs, Ba, Hf, Ta, W, Re, Os, Ir, Pt, Au, Fr, or Ra. It is preferable that the polyvalent metal has two or more valences and belongs to the fourth through seventh periods of the periodic table, and even more preferably has three or more valences. It is most desirable that the polyvalent metal is tin (Sn).

The element or compound of the polyvalent metal contributes to the fixing characteristics of the ink when forming an image. It is desirable that the mol ratio of the resin to the polyvalent metal in the ink composition is 1:6 through 10,000:1, and preferably 100:5 through 1,000:1.

If the mol ratio of the element or compound of the polyvalent metal to the resin is too small, then there may be cases where the wear resistance, the water resistance, the marker resistance and the fixing characteristics of the ink on the recording medium are unsatisfactory in the image formed by the ink composed of the ink composition according to the embodiment of the present invention. On the other hand, if the mol ratio of the element or compound of the polyvalent metal to the resin is too high, then there may be cases where the ejection stability of the aqueous ink declines.

Examples of the polyvalent metal compound used in the present embodiment include organic compounds and inorganic compounds constituted of tin, such as tin (II) chloride (SnCl₂), tin (IV) chloride (SnCl₄), tin (II) oxide (SnO), and tin (IV) oxide (SnO₂).

When an image is formed using the composed of the ink composition according to the embodiment of the present invention, which contains the resin and the element or compound of the polyvalent metal as described above, then the fixing characteristics of the ink, the water resistance and the wear resistance of the image are improved. It is considered that this improvement is caused by the action of the cationic compound or ions thereof toward ether bonds in the resin, which contributes the aggregation of the resin. Moreover, when the polyvalent metal of higher atomic weight is used, the probability of contact between the polyvalent metal and the polymer compound is increased, and hence the crosslinking density of the resin is increased. Therefore, it is desirable that the polyvalent metal having the high atomic weight is used.

In manufacturing the vinyl ether block copolymer, it is possible to use the polyvalent metal compound as a catalyst. As described in the Journal of Polymer Science: Part A: Polymer Chemistry, Vol. 43, 4288 (2005), it has been known that SnCl₄, which is constituted of tin as the polyvalent metal, increases the speed of cationic polymerization, and also restricts the molecular weight distribution. It is possible to add such the compound in advance, when polymerizing the polymer. In the case where the polyvalent metal is added when polymerizing, if the content of the polyvalent metal compound in the obtained block copolymer exceeds the above-described range, then it is desirable that the block copolymer is refined to reduce the content of the polyvalent metal, in order for the mol ratio of the polyvalent metal compound to the resin fall within the above-described mol ratio. Methods for refining the polymer are not particularly limited, and examples of the methods include a rinse with an acidic aqueous solution, dialysis, ultra-filtration, re-precipitation, adsorption separation using an adsorbent. Moreover, if the amount of the polyvalent metal compound remaining in the obtained block copolymer is known, then it is possible to achieve the above-described mol ratio by taking into consideration this remaining amount of the polyvalent metal compound when adjusting the used amounts of the resin and the polyvalent metal compound.

Examples of the coloring material usable in the present invention include: an acidic dye, a direct dye, a basic dye, an oil-soluble dye, a reactive dye, an edible dye, a vat dye, a soluble vat dye, a reactive dispersive dye, a dispersive dye, an inorganic pigment, an organic pigment. Taking the water resistance of the formed image into consideration, it is desirable that the coloring material is water-insoluble, more particularly the oil-soluble dye or the organic pigment, and even more particularly the organic pigment. Examples of dyes and pigments are given below, but the present invention is not limited to these examples.

Possible examples of the direct dye are: C.I. Direct Black 17, 19, 22, 32, 38, 51, 62, 71, 108, 146, and 154; C.I. Direct Yellow 12, 24, 26, 44, 86, 87, 98, 100, 130 and 142; C.I. Direct Red 1, 4, 13, 17, 23, 28, 31, 62, 79, 81, 83, 89, 227, 240, 242, 243; C.I. Direct Blue 6, 22, 25, 71, 78, 86, 90, 106 and 199; C.I. Direct Orange 34, 39, 44, 46 and 60; C.I. Direct Violet 47 and 48; C.I. Direct Brown 109; C.I. Direct Green 59; and the like.

Possible examples of the acidic dye include: C.I. Acid Black 2, 7, 24, 26, 31, 52, 63, 112, 118, 168, 172 and 208; C.I. Acid Yellow 11, 17, 23, 25, 29, 42, 49, 61 and 71; C.I. Acid Red 1, 6, 8, 32, 37, 51, 52, 80, 85, 87, 92, 94, 115, 180, 254, 256, 289, 315 and 317; C.I. Acid Blue 9, 22, 40, 59, 93, 102, 104, 113, 117, 120, 167, 229, 234 and 254; C.I. Acid Orange 7 and 19; and C.I. Acid Violet 49.

Possible examples of the reactive dye include: C.I. Reactive Black 1, 5, 8, 13, 14, 23, 31, 34, and 39; C.I. Reactive Yellow 2, 3, 13, 15, 17, 18, 23, 24, 37, 42, 57, 58, 64, 75, 76, 77, 79, 81, 84, 85, 87, 88, 91, 92, 93, 95, 102, 111, 115, 116, 130, 131, 132, 133, 135, 137, 139, 140, 142, 143, 144, 145, 146, 147, 148, 151, 162 and 163; C.I. Reactive Red 3, 13, 16, 21, 22, 23, 24, 29, 31, 33, 35, 45, 49, 55, 63, 85, 106, 109, 111, 112, 113, 114, 118, 126, 128, 130, 131, 141, 151, 170, 171, 174, 176, 177, 183, 184, 186, 187, 188, 190, 193, 194, 195, 196, 200, 201, 202, 204, 206, 218 and 221; C.I. Reactive Blue 2, 3, 5, 8, 10, 13, 14, 15, 18, 19, 21, 25, 27, 28, 38, 39, 40, 41, 49, 52, 63, 71, 72, 74, 75, 77, 78, 79, 89, 100, 101, 104, 105, 119, 122, 147, 158, 160, 162, 166, 169, 170, 171, 172, 173, 174, 176, 179, 184, 190, 191, 194, 195, 198, 204, 211, 216 and 217; C.I. Reactive Orange 5, 7, 11, 12, 13, 15, 16, 35, 45, 46, 56, 62, 70, 72, 74, 82, 84, 87, 91, 92, 93, 95, 97 and 99: C.I. Reactive Violet 1, 4, 5, 6, 22, 24, 33, 36 and 38; C.I. Reactive Green 5, 8, 12, 15, 19 and 23; and C.I. Reactive Brown 2, 7, 8, 9, 11, 16, 17, 18, 21, 24, 26, 31, 32, and 33.

Possible examples of the basic dye include: C.I. Basic Black 2: C.I. Basic Red 1, 2, 9, 12, 13, 14 and 27; C.I. Basic Blue 1, 3, 5, 7, 9, 24, 25, 26, 28 and 29; C.I. Basic Violet 7, 14 and 27; and C.I. Basic Black 1 and 2.

Possible examples of the oil-soluble dye include: C.I. Solvent Yellow 1, 2, 3, 13, 19, 22, 29, 36, 37, 38, 39, 40, 43, 44, 45, 47, 62, 63, 71, 76, 81, 85 and 86; C.I. Solvent Red 35, 36, 37, 38, 39, 40, 58, 60, 65, 69, 81, 86, 89, 92, 97, 99, 100, 109, 118, 119 and 122; C.I. Solvent Blue 14, 24, 26, 34, 37, 39, 42, 43, 45, 48, 52, 53, 55, 59 and 67; and C.I. Solvent Black 5, 8, 14, 17, 19, 20, 22, 24, 26, 28 and 43.

Possible examples of the pigment include: Colombian Carbon's Raven 760 Ultra, 1060 Ultra, 1080, 1100 Ultra, 1170, 1200, 1250, 1255, 1500, 2000, 2500 Ultra, 3500, 5250, 5750, 7000, 5000 ULTRAII and 1190 ULTRAII; Cabot's Black Pearls L, MOGUL-L, Regal 400R, 660R and 330R, Monarch 800, 880, 900, 1000, 1300 and 1400; Degussa's Color Black FW1, FW2, FW200, 18, S160 and S170, Special Black 4, 4A, 6 and 550, Printex 35, 45, 55, 85, 95, U, 140U, V, and 140V; Mitsubishi Chemical's No. 25, No. 33, No. 40, No. 45, No. 47, No. 52, No. 900, No. 970, No. 2200B, No. 2300, No. 2400B, MCF-88, MA600, MA77, MA8, MA100, MA230 and MA220; C.I. Pigment Blue 1, 2, 3, 15, 15:2, 15:3, 15:4, 16, 22 and 60; C.I. Pigment Red 5, 7, 12, 48, 48:1, 57, 112, 122, 123, 146, 168, 184, 202 and 207; a siloxane-crosslinked aluminum phthalocyanine described in U.S. Pat. No. 4,311,775; and C.I. Pigment Yellow 12, 13, 14, 16, 17, 74, 83, 93, 95, 97, 98, 114, 128, 129, 151 and 154.

It is desirable that the mass ratio (in solid content ratio) of the above-described coloring material to the resin in the ink is 1:0.01 through 1:2. If the amount of the resin is too little, then there may be cases where the fixing properties of the ink on the recording medium, such as the wear resistance, the water resistance and the marker resistance of the image formed by the ink, are unsatisfactory. On the other hand, if the amount of the resin is too great, then there may be cases where the viscosity of the aqueous ink becomes too high, and the ejection stability of the aqueous ink and the resistance to blockages decline.

When using the ink composition according to the embodiment of the present invention as the ink, it is desirable that the ink contains a medium in which the coloring material and the resin can be dispersed or dissolved. For the medium, it is possible to use an organic solvent (including a functional liquid organic compound, such as an electron beam-curable monomer, and an ultraviolet-curable monomer), water, or a mixture of organic solvent and water. It is desirable that the mixed solvent of water and water-soluble organic solvent is used as the aqueous medium of the aqueous ink. In the present invention, it is desirable that the percentage of the water-soluble organic solvent in the aqueous medium is 10 wt % through 90 wt %, preferably 20 wt % through 80 wt %, and even more preferably 25 wt % through 75 wt %.

In the ink composition according to the embodiment of the present invention, the water-soluble organic solvent is used for preventing solidification of the aqueous ink due to drying in the nozzle sections.

Possible examples of the water-soluble organic solvent include: a lower alcohol, such as methyl alcohol, ethyl alcohol, n-propyl alcohol, isopropyl alcohol, n-butyl alcohol, sec-butyl alcohol and tert-butyl alcohol; a diol, such as ethyelene glycol, diethylene glycol, triethylene glycol, tetraethylene glycol, propylene glycol, dipropylene glycol, tripropylene glycol, 1,2-butane diol, 1,3-butane diol, 1,4-butane diol, thiodiglycol and 1,4-cyclohexane diol; a triol, such as glycerine, 1,2,4-butane triol, 1,2,6-hexane triol and 1,2,5-pentane triol; a hindered alcohol, such as trimethylol propane, trimethylol ethane, neopentyl glycol and pentaerythritol; a glycol ether, such as ethylene glycol monomethyl ether, ethylene glycol monoethyl ether, ethylene glycol monoisopropyl ether, ethylene glycol monoaryl ether, diethylene glycol monomethyl ether, diethylene glycol monoethyl ether, triethylene glycol monomethyl ether, triethylene glycol monoethyl ether, propylene glycol monomethyl ether and dipropylene glycol monomethyl ether; and dimethyl sulphoxide, glycerine monoaryl ether, polyethylene glycol, N-methyl-2-pyrolidone, 2-pyrolidone, γ-butyrolactone, 1,3-dimethyl-2-imidazolidinone, sulfolane, β-dihydroxy ethyl urea, urea, acetonylacetone, dimethyl formamide, dimethyl acetamide, acetone, diacetone alcohol, tetrahydrofuran and dioxane.

Preferred examples of the water-soluble organic solvent include: glycerine, and polyhydric alcohol other than glycerine, for example, diethylene glycol, ethylene glycol, polyethylene glycol, and propylene glycol. It is also possible to use a combination of two or more of these various types of water-soluble organic solvents, in the aqueous ink.

In a preferred embodiment of the present invention, the ink composition contains water together with the water-soluble organic solvent described above. It is desirable that the percentage of water in the liquid composition or ink is 20 wt % through 90 wt %, preferably 30 wt % through 90 wt %, even more preferably 35 wt % through 80 wt %, and especially preferably 35 wt % through 70 wt %. In this case, the water used is preferably pure water or deionized water.

In the ink composition according to an embodiment of the present invention, it is desirable that the percentage of the coloring material with respect to the total weight of aqueous ink is 0.1 wt % through 20 wt %, and preferably 0.5 wt % through 10 wt %. If the percentage of the coloring material is less than 0.1 wt %, then it may be difficult to obtain sufficient image density in the printed image. On the other hand, if the percentage of the coloring material is greater than 20 wt %, then there may be cases where the ejection stability declines due to blockages in the nozzles, and moreover, the optical density may not be increased, variations in color hue may occur, and relatively undesirable results are obtained.

In the ink composition according to an embodiment of the present invention, it is desirable that the percentage of the resin with respect to the total weight of the ink composition is 0.001 wt % through 40 wt %, and preferably 0.01 wt % through 20 wt %. If the percentage of the resin is less than 0.001 wt %, then the wear resistance and the marker resistance of the obtained image may decline. On the other hand, if the percentage of the resin is greater than 40 wt %, then the viscosity of the ink rises, and the ejection stability may decline due to the occurrence of blockages of the aqueous ink in the nozzles, or the like.

In the ink according to an embodiment of the present invention, it is possible to add various agents, such as a surfactant, a pH adjuster, an antioxidant, an antibacterial agent, or the like, along with the components described above. Moreover, in the aqueous ink according to an embodiment of the present invention, it is desirable that the viscosity of the aqueous ink at 25° C. is 1.0 mPa·s through 20 mPa·s, preferably 1.0 mPa·s through 10 mPa·s, and even more preferably 2.0 mPa·s through 8.0 mPa·s.

The inkjet recording apparatus according to an embodiment of the present invention forms images by using the ink according to the above-described embodiment of the present invention.

In the inkjet recording method according to an embodiment of the present invention, images are formed by means of an inkjet recording apparatus using the ink according to the above-described embodiment of the present invention. In the inkjet recording method, the ink is ejected by thermal energy or mechanical energy, for example, and preferably by thermal energy. In the inkjet recording method, there are no restrictions on the recording medium used, and it is desirable to use a recording medium known as a special inkjet paper, which has a coating layer for receiving the ink on at least one surface thereof. For example, a desirable recording medium has a coating layer for receiving ink on at least one surface thereof, and the layer contains at least one of a hydrophilic polymer and an inorganic porous material. An image formed by means of this inkjet recording method has excellent ink fixing properties, and good wear resistance, water resistance and marker resistance.

### EXAMPLES

Next, the present invention will be described in more specific terms with reference to manufacturing examples, practical examples, and comparative examples, but the present invention is not limited to the practical examples described below, to the extent that it does not deviate from the scope of the present invention. In the following description, unless specified otherwise, indications referring to percentages are based on weight. In the examples described below, the molecular weight and the molecular weight distribution of the resin were measured by gel permeation chromatography (GPC), and the concentration of tin was measured with an inductively coupled plasma atomic emission spectrometer (ICP-AES).

### Manufacturing Example 1

A triblock copolymer (hereinafter referred to as a resin T) of an A-B-C type constituted of blocks A, B, and C was synthesized. The blocks A, B, and C have the following repeating units, respectively.

| | | |
|---|---|---|
| A: | 1-isobutoxyethyl vinyl ether | (molecular weight: 144.21) |
| B: | 2-methoxyethyl vinyl ether | (molecular weight: 102.13) |
| C: | 4-(2-vinyl oxyethoxy) benzoate | (molecular weight: 196.19) |

The atmosphere inside a glass vessel provided with a three-way tap was substituted with nitrogen, and then heated to 250° C. in the nitrogen gas atmosphere, thereby removing adsorbed water. After returning the system to room temperature, 1-isobutoxyethyl vinyl ether of 12 millimoles, ethyl acetate of 16 millimoles, 1-isobutoxy ethyl acetate of 0.1 millimoles and toluene of 11 milliliters were mixed together in the glass vessel, and when the system temperature reached 0° C., ethylaluminum sesquichloride of 0.2 millimoles was mixed to start polymerization, thereby synthesizing the block A constituting the triblock copolymer (the resin T).

The molecular weights of the substances in the system were monitored by time division, using a molecular-sieve column chromatography (GPC), until the synthesis of the block A was completed. Thereupon, 2-methoxy ethyl vinyl ether of 12 millimoles was mixed to add the block B, and the completion of the addition of the block B was then confirmed by monitoring using the GPC similarly. Thereupon, 4-(2-vinyl oxyethoxy)benzoate ethyl of 12 millimoles was mixed to add the block C, and then the polymerization reaction was halted by mixing a methanol solution of 0.3% ammonia to the system. Finally, the ester benzoate was carboxylated in a mixed solvent of methanol and five times equivalent amount of sodium hydroxide aqueous solution.

The molecular weight of the obtained substance was measured using the GPC, and the following results were obtained: Mn=3.7×10⁴; and Mn/Mw=1.3, where Mn is a number-averaged molecular weight (standard polystyrene conversion), and Mw is a weight-averaged molecular weight (standard polystyrene conversion).

### Manufacturing Example 2

Using a similar method to the manufacturing example 1, it was possible to manufacture a material having similar molecular weight and similar molecular weight distribution, by cooling the system to −78° C. and then mixing tin (IV) chloride of 0.25 millimoles and 50 millimoles of ethyl chloroacetate, in addition to ethylaluminum sesquichloride of 0.2 millimoles.

In order to adjust the content of tin in the resin thus obtained, the samples of the resins were rinsed with 0.6 N aqueous hydrochloric acid, thereby refining the resins in such a manner that the mol ratio of the resin to tin in the samples assumed the values shown in Table 1, thus obtaining tin-containing resins having mutually different tin contents.

Resins containing compounds of metals other than tin were also prepared by adding iron (II) nitrate and zinc chloride, respectively, after manufacturing the polymers.

TABLE 1

| | | | | Mol ratio |
|---|---|---|---|---|
| | | | | (resin/ |
| | Polyvalent | Atomic | | polyvalent |
| | metal | weight | Valence | metal) |
| Comparative example 1 | aluminum | 26.98 | 3 | 100/5 |
| Comparative example 2 | iron | 55.84 | 2 | 100/5 |
| Practical example 1 | zinc | 65.39 | 2 | 100/5 |
| Practical example 2 | tin | 118.7 | 4 | 100/5 |
| Practical example 3 | | | | 1000/2 |
| Comparative example 3 | | | | 100000/5 |
| Comparative example 4 | | | | 1/10 |

### Practical Examples 1 to 6 and Comparative Examples 1 to 4

The aqueous inks in the practical examples 1 to 3 of the present invention and the comparative examples 1 to 4 were prepared as follows. 5% of the resin T with the polyvalent metal prepared as described above, 5% of C.I. Solvent Yellow 1 as a coloring material, 10% of glycerine, 10% of diethylene glycol and 1.5% of Olfine E1010 (manufactured by Nissin Chemical Industry) were mixed together and then agitated for ten minutes, then water was added in order to finally achieve a 5% solid content of the coloring material in the aqueous ink, and the mixture was then agitated for one hour. The aqueous ink obtained through this process was filtered by using a membrane filter having a mesh size of 5 μm.

The ink in a practical example 4 was prepared similarly to the practical example 2, with the exception that the coloring material was changed from C.I. Solvent Yellow 1 to C.I. Solvent Red 27.

The ink in a practical example 5 was prepared similarly to the practical example 2, with the exception that the coloring material was changed from C.I. Solvent Yellow 1 to C.I. Solvent Blue 44.

The ink in a practical example 6 was prepared similarly to the practical example 3, with the exception that the coloring material was changed from C.I. Solvent Yellow 1 to C.I. Direct Black 17.

Using the inks of the practical examples 1 to 6 and the comparative examples 1 to 4 described above, recording was carried out. The recording papers used were a C2 paper (manufactured by Fuji Xerox) and a Tokubishi double-sided art paper N (manufactured by Mitsubishi Paper Mills). This image formation (printing) was carried out by using an aqueous inkjet printer F660 (manufactured by Canon). The print results were evaluated as described below, and the evaluation results are shown in Table 2.

### Wear Resistance

The paper was left for 24 hours after printing, then a sheet of the Tokubishi double-sided art paper N was placed on the printed paper, and a 1.5 kg/cm² weight was placed thereon and moved back and forth five times. Thereupon, the soiling of the white margin area, and the wearing of the printed solid image and text area, were observed visually. The evaluation criteria were as follows.

A: No soiling in white margin area; and no wearing of solid image and text area

B: Slight soiling in white margin area; and slight wear marks in solid image and/or text area

C: Soiling in white margin area; portion of solid image and/or text area worn away.

### Water Resistance

The paper was left for at least 12 hours after printing, then the reflection density of the printed image was measured. Thereafter, the printed paper was immersed in running water for five minutes and then dried, and the reflection density of the printed image was measured again. The percentage of the residual reflective density after the water resistance test with respect to the initial reflective density was calculated, and it was taken as a parameter for evaluating the water resistance. The evaluation criteria were as follows.

A: Residual image density of 90% or above

B: Residual image density equal to or greater than 80% and less than 90%

C: Residual image density equal to or greater than 70% and less than 80%

### Marker Resistance

The paper was left for at least 12 hours after printing, then the printed text area was marked once under normal pen pressure, using a fluorescent yellow pen (manufactured by Zebra), and the marker resistance was evaluated on the basis of the following evaluation criteria.

A: No bleeding in text area and no soiling in white margin area observed, and no soiling of pen tip

B: Slight soiling in white margin area and slight bleeding in text area

C: Soiling in white margin area and bleeding in text area

### Ejection Characteristics

The state of the printed image and the heater surface of the inkjet head after printing were observed and evaluated according to the following evaluation criteria.
A: Solid image area and text area can be printed sufficiently clearly, and virtually no accumulation of material is observed on heater surface
B: Solid image area and text area can be printed sufficiently clearly, but slight accumulation of material is observed on heater surface
C: Printing in solid image area and text area is unclear, and large amount of accumulated material is observed on heater surface

TABLE 2

| | Wear | | Water | | Marker | | |
|---|---|---|---|---|---|---|---|
| | resistance | | resistance | | resistance | | |
| | Normal | Art | Normal | Art | Normal | Art | |
| | paper | paper | paper | paper | paper | paper | Ejectability |
| Comparative example 1 | B | C | A | A | B | C | A |
| Comparative example 2 | B | C | A | A | A | A | A |
| Practical example 1 | A | B | A | A | A | A | A |
| Practical example 2 | A | A | A | A | A | A | A |
| Practical example 3 | A | A | A | A | A | A | A |
| Comparative example 3 | B | C | B | A | B | C | A |
| Comparative example 4 | — | — | — | — | — | — | C |
| Practical example 4 | A | A | A | A | A | A | A |
| Practical example 5 | A | A | A | A | A | A | A |
| Practical example 6 | A | A | A | A | A | A | A |

In the case of the comparative example 4 shown in Table 2, it was not possible to perform ejection and hence the other evaluations could not be made.

As shown in Table 2, by using the aqueous inks of the practical examples 1 to 6, satisfactory results were obtained for both normal paper and art paper.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An ink composition, comprising:
a coloring material;
a resin which is a block copolymer constituted of at least one hydrophilic block and at least one hydrophobic block; and
one of an element and a compound of a polyvalent metal having an atomic weight of not less than 65,
wherein a mol ratio of the resin to the one of the element and the compound of the polyvalent metal is 1:6 through 10000:1.

2. The ink composition as defined in claim 1, wherein the block copolymer is a vinyl ether copolymer.

3. The ink composition as defined in claim 1, wherein the polyvalent metal belongs to fourth through seventh periods in periodic table.

4. The ink composition as defined in claim 1, wherein the polyvalent metal has not less than three valences.

5. The ink composition as defined in claim 1, wherein the polyvalent metal is tin.

6. The ink composition as defined in claim 1, wherein the mol ratio of the resin to the one of the element and the compound of the polyvalent metal is 100:5 through 1000:1.

7. The ink composition as defined in claim 1, wherein the coloring material is dispersed in liquid.

8. The ink composition as defined in claim 1, further comprising at least one of a hydrophilic organic solvent and water.

9. An ink for inkjet recording, comprising the ink composition as defined in claim 1.

10. An ink set for inkjet recording, comprising the ink for inkjet recording as defined in claim 9.

11. An inkjet recording apparatus, comprising the ink for inkjet recording as defined in claim 9.

12. An inkjet recording apparatus, comprising the ink set for inkjet recording as defined in claim 10.

13. An inkjet recording method, comprising the step of forming an image on a recording medium by means of an inkjet recording apparatus using the ink for inkjet recording as defined in claim 9.

14. An inkjet recording method, comprising the step of forming an image on a recording medium by means of an inkjet recording apparatus using the ink set for inkjet recording as defined in claim 10.

15. The inkjet recording method as defined in claim 13, wherein the recording medium is art paper.

16. The inkjet recording method as defined in claim 14, wherein the recording medium is art paper.
